(19) United States
(12) Patent Application Publication
(10) Pub. No.: US 2025/0196702 A1
(43) Pub. Date: Jun. 19, 2025

(54) CONTROL DEVICE AND CONTROL METHOD

(71) Applicant: TOYOTA JIDOSHA KABUSHIKI KAISHA, Toyota-shi (JP)

(72) Inventor: Shinji ICHIKAWA, Nagoya-shi (JP)

(73) Assignee: TOYOTA JIDOSHA KABUSHIKI KAISHA, Toyota-shi (JP)

(21) Appl. No.: 18/951,671

(22) Filed: Nov. 19, 2024

(30) Foreign Application Priority Data
Dec. 18, 2023 (JP) 2023-213082

(51) Int. Cl. B60L 53/80; B60L 53/65; B60L 53/66; H01M 10/42

(52) U.S. Cl. CPC B60L 53/80; B60L 53/65; B60L 53/66; H01M 10/425; B60L 2250/00; H01M 2010/4278; H01M 2220/20

(57) ABSTRACT

The control device of electrified vehicle includes a communication unit capable of receiving data stored in servers, and a processor. The server stores battery characteristic information indicating a characteristic of the battery when electrified vehicle is driven, in association with battery specific information specific to the battery. When the battery is replaced, the processor acquires the battery characteristic information corresponding to the battery specific information of the replaced battery from the server through the communication unit, and changes the vehicle control in electrified vehicle using the battery characteristic information acquired from the server.

### CROSS-REFERENCE TO RELATED APPLICATION

This application claims priority to Japanese Patent Application No. 2023-213082 filed on Dec. 18, 2023, incorporated herein by reference in its entirety.

### BACKGROUND

### 1. Technical Field

The present disclosure relates to a control device and a control method.

### 2. Description of Related Art

Japanese Unexamined Patent Application Publication No. 2023-101504 (JP 2023-101504 A) discloses a vehicle mounted with a replaceable battery pack.

### SUMMARY

While not clearly described in JP 2023-101504 A, there are cases where a battery pack mounted on the vehicle by a battery replacement is not limited to a specific type of battery pack. Accordingly, there are cases where a battery pack inappropriate for the vehicle is mounted on the vehicle. In this case, there is a risk that a vehicle performance deteriorates.

The present disclosure has been made in order to solve the problem, and an objective of the present disclosure is to provide a control device and a control method that can suppress a performance of a vehicle from deteriorating due to a battery pack mounted by a battery replacement.

A first aspect of the present disclosure is a control device that controls an electrified vehicle mounted with a replaceable battery, the control device including a communication unit that is able to receive information stored in a storage device, and
a processor, in which
the storage device stores battery characteristic information that shows a characteristic of the battery at a time of driving of the electrified vehicle in association with battery specific information unique to the battery, and
when the battery is replaced, the processor is configured to
acquire the battery characteristic information corresponding to the battery specific information of the battery after a replacement from the storage device through the communication unit, and
change a vehicle control in the electrified vehicle by using the battery characteristic information obtained from the storage device.

In the control device relating to the first aspect of the present disclosure, when the battery is replaced, the processor acquires the battery characteristic information corresponding to the battery specific information of the battery after the replacement, and changes a vehicle control in the electrified vehicle by using the acquired battery characteristic information. Accordingly, a vehicle control suitable for a battery characteristic of the battery after the replacement can be performed by using the battery characteristic information corresponding to the battery after the replacement. As a result, a performance of the vehicle deteriorating due to a battery pack mounted by a battery replacement can be suppressed.

In the control device relating to the first aspect, the processor may notify information related to a change of the vehicle control to a user of the electrified vehicle when the vehicle control is changed by using the battery characteristic information corresponding to the battery after the replacement.

According to the configuration, the user can recognize that the vehicle control has been changed due to the battery being replaced.

In the control device relating to the first aspect, the processor may notify information related to the change to the user by transmitting information related to the change to at least one of a display device mounted on the electrified vehicle and a user terminal possessed by the user.

According to the configuration, since the user can visually recognize information related to the change, the vehicle control being changed can be easily transmitted to the user.

In the control device relating to the first aspect, when the battery characteristic information corresponding to the battery after the replacement is stored in the storage device, the processor may be configured to
determine whether or not it is necessary to change the vehicle control based on the battery characteristic information corresponding to the battery after the replacement stored in the storage device,
change the vehicle control when it is determined that it is necessary to change the vehicle control, and maintain a current vehicle control when it is determined that it is not necessary to change the vehicle control, and
when the battery characteristic information corresponding to the battery after the replacement is not stored in the storage device, the processor may be configured to maintain the current vehicle control.
   According to the configuration, the vehicle control can be changed only when it is determined that it is necessary to change the vehicle control based on the battery characteristic information stored in the storage device.

A second aspect of the present disclosure is a control method that controls an electrified vehicle mounted with a replaceable battery, the control method including
acquiring battery characteristic information that shows a characteristic of the battery at a time of driving of the electrified vehicle from a storage device that stores the battery characteristic information in association with battery specific information unique to the battery, the battery characteristic information corresponding to the battery specific information of the battery after a replacement, and
changing a vehicle control of the electrified vehicle when the battery is replaced by using the battery characteristic information corresponding to the battery after the replacement acquired in the acquiring.

In the control method relating to the second aspect of the present disclosure, when the battery is replaced, the vehicle control in the electrified vehicle is changed by using the battery characteristic information corresponding to the battery specific information of the battery after the replacement. Accordingly, a control method can be provided that can suppress a performance of a vehicle from deteriorating due to a battery pack mounted by a battery replacement.

According to the present disclosure, a performance of a vehicle deteriorating due to a battery pack mounted by a battery replacement can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a battery replacement system according to a first embodiment;

FIG. 2 is a diagram illustrating a table stored in a server according to the first embodiment;

FIG. 3 is a first diagram illustrating the sequencing of control between servers and electrified vehicle according to the first embodiment;

FIG. 4 is a second diagram showing the sequencing of control between servers and electrified vehicle according to the first embodiment;

FIG. 5 is a diagram showing a screen on which the contents related to the change of the vehicle control according to the first embodiment are displayed;

FIG. 6 is a diagram illustrating a configuration of a battery replacement system according to a second embodiment;

FIG. 7 shows a table stored in memories of a vehicle ECU according to a second embodiment;

FIG. 8 is a first diagram showing the sequencing of control between servers and electrified vehicle according to a second embodiment; and

FIG. 9 is a second diagram illustrating a sequence of control between servers and electrified vehicle according to the second embodiment.

### DETAILED DESCRIPTION OF EMBODIMENTS

Hereinafter, an embodiment of the present disclosure will be described in detail with reference to the drawings. The same or corresponding parts in the drawings are designated by the same reference signs and repetitive description will be omitted.

### First Embodiment

### Configuration of Battery Replacement System

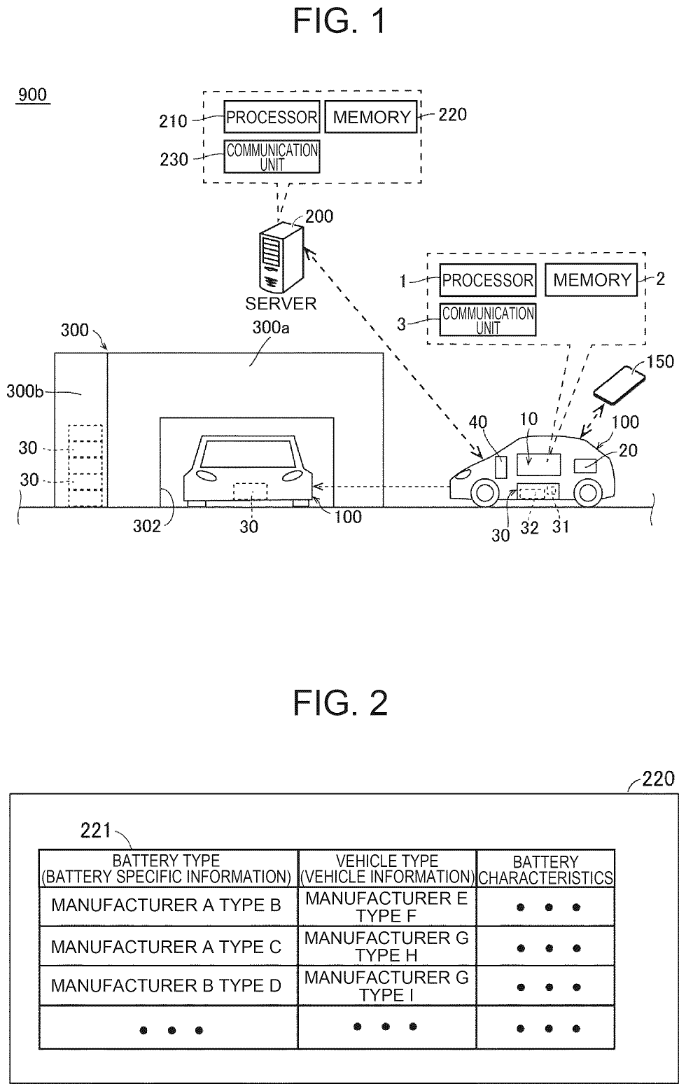

FIG. 1 is a diagram illustrating a battery replacement system 900 including an electrified vehicle 100, servers 200, and a battery replacement device 300 according to a first embodiment. Note that the server 200 is an example of a “storage device” of the present disclosure.

Electrified vehicle 100 includes a vehicle Electronic Control Unit (ECU) 10, a Data Communication Module (DCM) 20, a battery-pack 30, and a car navigation device 40. The battery pack 30 is replaceable in the battery replacement device 300. Note that the vehicle ECU 10 and the battery pack 30 are exemplary “control devices” and “battery” of the present disclosure, respectively.

Note that the user of electrified vehicle 100 owns the user terminal 150 (for example, a smart phone).

Electrified vehicle 100 is, for example, Plug-in Hybrid Electric Vehicle (PHEV), Battery Electric Vehicle (BEV), or Fuel Cell Electric Vehicle (FCEV).

The battery pack 30 includes a battery ECU 31 and a plurality of battery cells 32. Each of the plurality of battery cells 32 stores electric power used for driving (traveling, etc.) electrified vehicle 100. The battery ECU 31 manages (controls) each of the plurality of battery cells 32. Further, the battery ECU 31 stores information unique to the battery pack 30 (for example, information on the type of battery).

DCM 20 is configured to be able to communicate with a communication device outside the vehicles. DCM 20 can communicate with servers 200 (communication units 230 described later). DCM 20 may be capable of communicating with the user terminal 150.

The car navigation device 40 displays various kinds of information (for example, map information and video content) on a display screen, and notifies various kinds 25 of information (for example, traffic information, weather information, and the like) by voice.

The vehicle ECU 10 includes a processor 1, memories 2, and a communication unit 3. In the memory 2, in addition to the program executed by the processor 1, information (for example, a map, a mathematical expression, and various parameters) used in the program is stored.

The communication unit 3 communicates with each of DCM 20, the battery ECU 31, and the car navigation device 40 by, for example, CAN (Controller Area Network) communication.

The server 200 includes a processor 210, a memory 220, and a communication unit 230. The memory 220 stores a program to be executed by the processor 210 and information (for example, a map, a mathematical expression, and various parameters) used in the program.

The memory 220 stores a table 221 illustrated in FIG. 2. In the table 221, a battery type, a vehicle type, and a battery characteristic are stored in association with each other. The battery type information (hereinafter referred to as battery specific information) includes information of a battery manufacturer and information of a type of a battery. The vehicle type information (hereinafter, referred to as vehicle information) includes information of the vehicle manufacturer and information of the type of the vehicle. The battery characteristic information indicates a characteristic of the battery pack when the vehicle is driven (traveling, charging, and the like). Note that the battery type information is an example of “battery specific information” of the present disclosure.

The information of the table 221 is created based on the information of the properties of the battery pack 30 when each of the plurality of electrified vehicle including electrified vehicle 100 is driven (traveling, charging, and the like). For example, it is assumed that electrified vehicle 100 is a type F vehicle of the manufacturer E and is equipped with a type B battery pack 30 of the manufacturer A. In this case, electrified vehicle 100 transmits the characteristics of the battery pack 30 (information such as output voltage, output power, and battery temperature) when electrified vehicle 100 is driven to the servers 200. Then, the information of the table 221 (the battery specific information of the type B of the manufacturer A and the battery characteristic information corresponding to the vehicle information of the type F of the manufacturer E) stored in the memory 220 of the server 200 is updated based on the information from electrified vehicle 100. When the memory 220 does not store the battery specific information of the type B of the manufacturer A and the battery characteristic information corresponding to the vehicle information of the type F of the manufacturer E, the information from electrified vehicle 100 is newly registered in the memory 220.

The communication unit 230 is configured to be able to communicate with DCM 20 of electrified vehicle 100. The communication unit 230 may be capable of communicating with the user terminal 150.

Referring back to FIG. 1, the battery replacement device 300 includes a battery replacement device main body 300a in which battery replacement is performed, and a storage 300b in which the battery pack 30 is stored. Various types of battery 30 may be stored in the storage 300b. The battery replacement device main body 300a is an apparatus that performs battery replacement in which the battery pack 30 mounted on electrified vehicle 100 is replaced with the battery pack 30 stored in the storage. The storage 300b is installed in the battery replacement device main body 300a. The battery replacement device 300 (battery replacement device main body 300a) is provided with an entrance 302 for electrified vehicle 100 to and from.

Here, in a conventional battery replacement system, a battery pack mounted on a vehicle by battery replacement may not be limited to a specific type of battery pack. Accordingly, there are cases where a battery pack inappropriate for the vehicle is mounted on the vehicle.

Therefore, in the first embodiment, when the battery pack 30 is replaced, the processor 1 acquires the battery characteristic information corresponding to the battery specific information of the battery pack 30 after the replacement from the server 200 (the memory 220) through the communication unit 3. Specifically, the processor 1 acquires, from the servers 200, the battery characteristic information corresponding to the battery specific information of the battery pack 30 after the replacement and the vehicle information of electrified vehicle 100.

Then, the processor 1 changes the vehicle control in electrified vehicle 100 using the battery characteristic information acquired from the servers 200. For example, the processor 1 may reduce the maximum value of the output power (voltage) of the battery from a normal state (for example, a reference value or the like specified by the specification) when information indicating that the increase in the battery temperature at the time of driving electrified vehicle 100 is large is included in the battery characteristic information. Control Method for Change of Vehicle Control

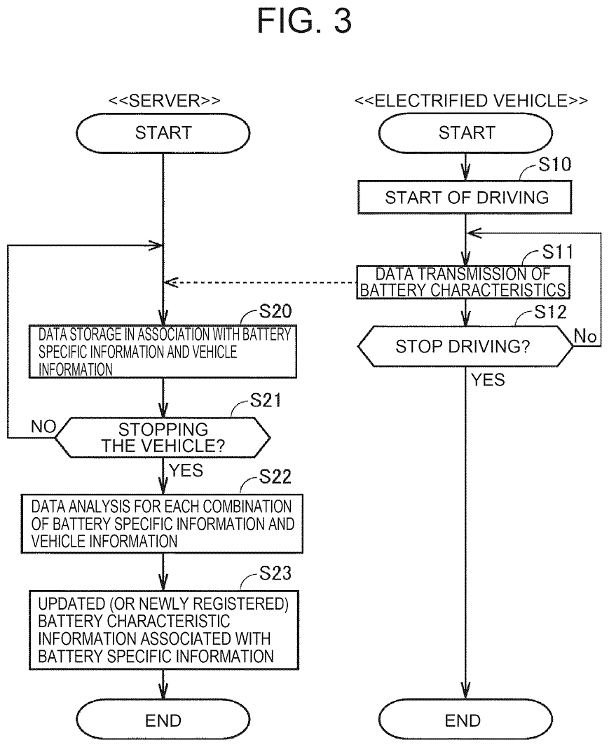

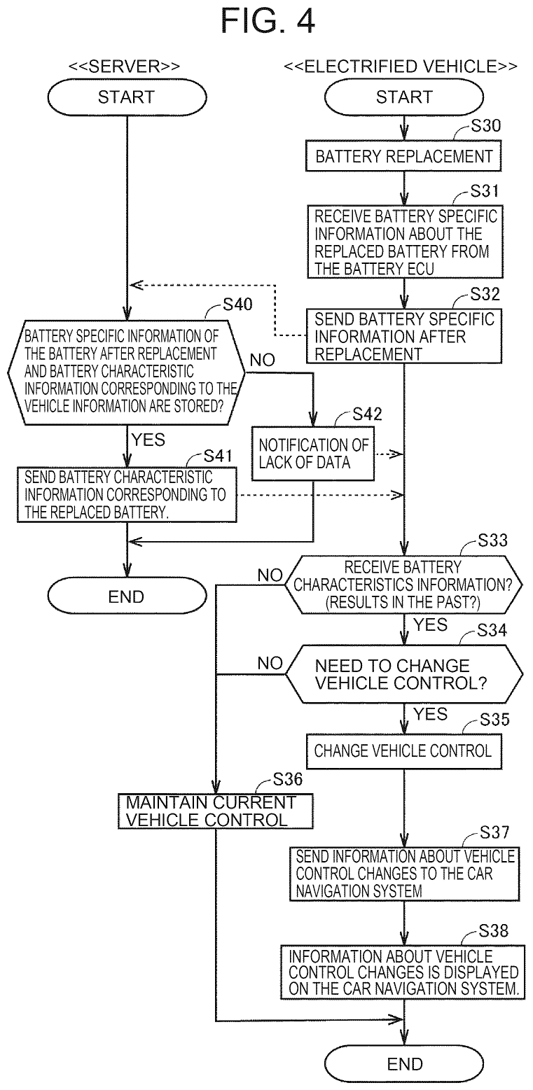

Referring now to FIG. 3 and FIG. 4, control methods relating to changes in the vehicle control of electrified vehicle 100 vehicles will be described.

FIG. 3 shows a sequence when the information of the servers 200 is updated based on the battery characteristic information when electrified vehicle 100 is driven. First, it is assumed that traveling of electrified vehicle 100 is started in S10.

In S11, the vehicle ECU 10 transmits data of battery properties (data such as battery power, battery voltage, and battery temperature) of the battery pack 30 when electrified vehicle 100 travels to the servers 200 through DCM 20. Specifically, the processor 1 of the vehicle ECU 10 acquires the information from the battery ECU 31 through the communication unit 3 of the vehicle ECU 10. The processor 1 transmits the data to DCM 20 through the communication unit 3 and transmits the data to the servers 200 through DCM 20. At this time, electrified vehicle 100 data may also be transmitted to the servers 200.

In S12, the vehicle ECU 10 determines whether or not the travel of electrified vehicle 100 has stopped. For example, the vehicle ECU 10 may determine whether the traveling of electrified vehicle 100 is stopped based on a change in position information of electrified vehicle 100 by a GPS (not shown), a change in a detected value of an acceleration sensor (velocity sensor) (not shown), or the like. When electrified vehicle 100 has stopped running (S12 is Yes), electrified vehicle 100 process ends. If electrified vehicle 100 has not stopped running (No in S12), the process returns to S11.

In S20, the servers 200 store S11 data in association with the battery specific information of the battery pack 30 and electrified vehicle 100 vehicle information. The data may be stored in the memory 220.

In S21, the servers 200 determine whether or not electrified vehicle 100 has stopped running. For example, the servers 200 may determine that electrified vehicle 100 has stopped based on a notification from electrified vehicle 100, or may determine based on a change in electrified vehicle 100 position data or the like. When it is determined that the traveling of electrified vehicle 100 is stopped, the process proceeds to S22. When it is determined that the traveling of electrified vehicle 100 is not stopped, the process returns to S20.

In S22, the servers 200 perform data analysis for each combination of the battery specific information and the vehicle-information by using the data of S11.

In S23, the servers 200 update the battery characteristic information associated with the battery specific information. Specifically, the server 200 updates the battery characteristic information corresponding to the combination of the battery specific information on which the data analysis is performed in S22 and the vehicle-information based on the analysis of S22. When the battery characteristic information corresponding to the above-described combination is not stored in the server 200 at the time of S23, the information based on the analysis of S22 is newly registered in the memory 220.

FIG. 4 is a diagram showing a sequence for changing the vehicle control of electrified vehicle 100 based on the battery characteristic information stored in the server 200. In S30, it is assumed that electrified vehicle 100 battery pack 30 is replaced in the battery replacement device 300.

In S31, the vehicle ECU 10 receives the battery specific information of the battery pack 30 after the replacement from the battery ECU 31 through the communication unit 3.

In S32, the vehicle ECU 10 transmits the battery specific information of the replaced battery pack 30 acquired in S31 to the server 200 through DCM 20. Specifically, the processor 1 of the vehicle ECU 10 transmits the battery specific information to DCM 20 through the communication unit 3 of the vehicle ECU 10, and transmits the battery specific information to the servers 200 through DCM 20. In S32, electrified vehicle 100 may also transmit electrified vehicle 100 information to the servers 200.

In S40, the servers 200 determine whether or not battery characteristic information corresponding to the battery specific information of S32 and the vehicle information of electrified vehicle 100 is stored in the memory 220. That is, the server 200 determines whether or not there is a track record in which the battery specific information and the battery-characteristic data corresponding to the vehicle-information are acquired in electrified vehicle 100. If the battery characteristic information is stored (Yes in S40), the process proceeds to S41. If no battery characteristic information is stored (No in S40), the process proceeds to S42.

In S41, the servers 200 transmit battery characteristic information corresponding to the replaced battery pack 30 and electrified vehicle 100 vehicle information to electrified vehicle 100. Thereafter, the control of the server 200 ends.

In S42, the server 200 transmits information (information indicating that there is no data) indicating that the battery characteristic information corresponding to the replaced battery pack 30 and electrified vehicle 100 vehicle information is not stored in the memory 220 to electrified vehicle 100. Note that the information indicating that there is no data may be transmitted to the user terminal 150. Thereafter, the control of the server 200 ends.

In S33, the vehicle ECU 10 determines whether or not S41 battery characteristic information has been received. That is, the vehicle ECU 10 determines whether or not the battery specific information of the battery pack 30 after the replacement has been combined with the vehicle information of electrified vehicle 100. When the battery characteristic information is received (Yes in S33), the process proceeds to S34. When the battery characteristic information is not received (S42 notification is received) (No in S33), the process proceeds to S36.

In S34, the vehicle ECU 10 determines whether the vehicle control needs to be changed based on the battery characteristic information received in S33. For example, the vehicle ECU 10 may compare the output power, the output voltage, the temperature characteristic, and the like in the battery pack 30 after the replacement, which are included in the battery characteristic information, with an allowable value set in electrified vehicle 100, and make the above-described determination. If the vehicle control needs to be changed (Yes in S34), the process proceeds to S35. If the vehicle control does not need to be changed (No in S34), the process proceeds to S36.

In S35, the vehicle ECU 10 changes the vehicle control based on the determination in S34. Specifically, the vehicle ECU 10 changes control parameters, thresholds, and the like in the vehicle control based on the determination. For example, the vehicle ECU 10 changes an upper limit (lower limit), a charge duration, a cruising distance, a power cost, and the like of the output power, the regenerative power, and SOC (State of Charge) in the battery pack 30 after the replacement. The process then proceeds to S37.

In S36, the vehicle ECU 10 maintains the current vehicle control. In other words, the vehicle ECU 10 does not change the vehicle control. Thereafter, the control of the vehicle ECU 10 ends.

The vehicle ECU 10 notifies the user of electrified vehicle 100 of the change of the vehicle control in S35.

Specifically, in S37, the processor 1 of the vehicle ECU 10 transmits, to the car navigation device 40, the information regarding the change of the vehicle control through the communication unit 3.

Next, in S38, the processor 1 of the vehicle ECU 10 displays S37 on the car navigation device 40. Specifically, the processor 1 transmits a command signal for displaying the information to the car navigation device 40 through the communication unit 3.

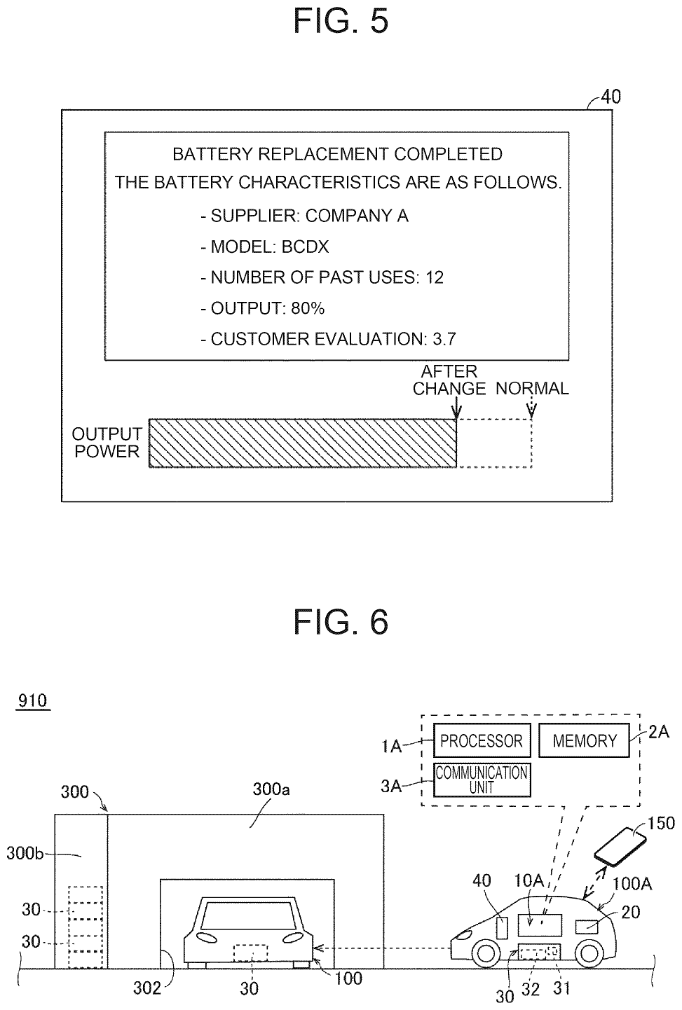

FIG. 5 shows exemplary images displayed on the car navigation device 40 in S38. In the example illustrated in FIG. 5, the car navigation device 40 displays battery specific information, usage results, battery characteristics, evaluation by the user, and the like of the battery pack 30 after replacement. Further, the car navigation device 40 displays the contents changed by the change of the vehicle control. In the example illustrated in FIG. 5, information on the output power of the battery pack 30 at the normal time (before the change) (see the broken line in FIG. 5) and information on the output power of the battery pack 30 after the change of the vehicle control (the hatched line in FIG. 5) are displayed.

In the example illustrated in FIG. 5, a change in the output power of the battery pack 30 (a change in vehicle control) is represented by a change in the length of the displayed gauge. The change in the vehicle control may be represented by a change in the display form of the icon.

As described above, in the first embodiment, when the battery pack 30 is replaced, the processor 1 acquires the battery characteristic information corresponding to the battery specific information of the battery pack 30 after the replacement from the server 200, and changes the vehicle control in electrified vehicle 100 using the acquired battery characteristic information. Accordingly, since electrified vehicle 100 is controlled based on the battery characteristic information of the battery pack 30 after the replacement, it is possible to suppress inappropriate vehicle control from being executed for the battery pack 30 after the replacement. As a consequence, it is possible to suppress the performance of electrified vehicle 100 from deteriorating due to the battery pack 30 mounted by the battery replacement.

In addition, in the first embodiment, the servers 200 perform data analysis on the basis of the information of the battery properties acquired from each of the plurality of electrified vehicle 100. As a result, it is possible to easily increase the amount of data to be used for analysis, and thus it is possible to obtain (calculate) more effective (highly reliable) battery characteristic information in order to suppress deterioration in the performance of electrified vehicle 100.

### Second Embodiment

Next, a configuration according to the second embodiment will be described with reference to FIGS. 6 to 9. The battery replacement system 910 of the second embodiment does not include a server, unlike the first embodiment in which the battery replacement system 900 includes the server 200 and electrified vehicle 100. Note that the same components as those in the first embodiment are denoted by the same reference numerals and will not be described repeatedly.

### Configuration of Battery Replacement System

FIG. 6 is a diagram illustrating a battery replacement system 910 including an electrified vehicle 100A according to a second embodiment and a battery replacement device 300.

Electrified vehicle 100A differs from electrified vehicle 100 of the first embodiment in that a vehicle ECU 10A is included in place of the vehicle ECU 10. Note that the vehicle ECU 10A is an exemplary “control device” of the present disclosure.

The vehicle ECU 10A includes a processor 1A, a memory 2A, and a communication unit 3A. The memory 2A stores programs to be executed by the processor 1A, as well as information (for example, maps, mathematical expressions, and various parameters) used in the programs. Note that the memory 2A is an exemplary “storage device” of the present disclosure.

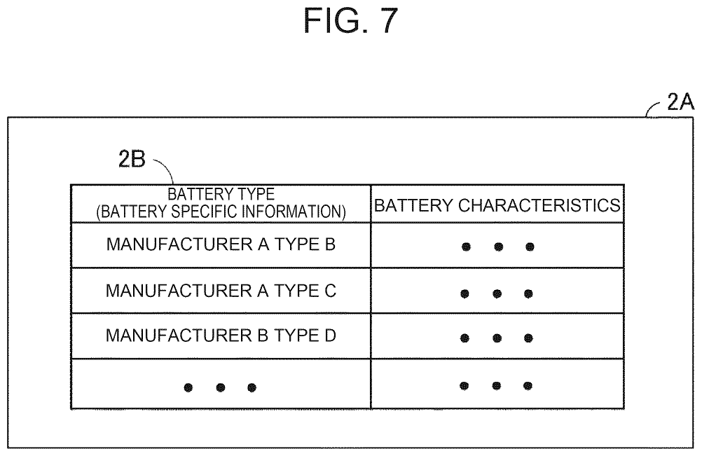

The memory 2A stores the table 2B shown in FIG. 7. In the table 2B, the battery characteristic information is stored in association with the battery type information (battery specific information). The table 2B is updated based on the properties of the battery-pack 30 when electrified vehicle 100A is driven (traveling, charging, and the like). Control Method for Change of Vehicle Control

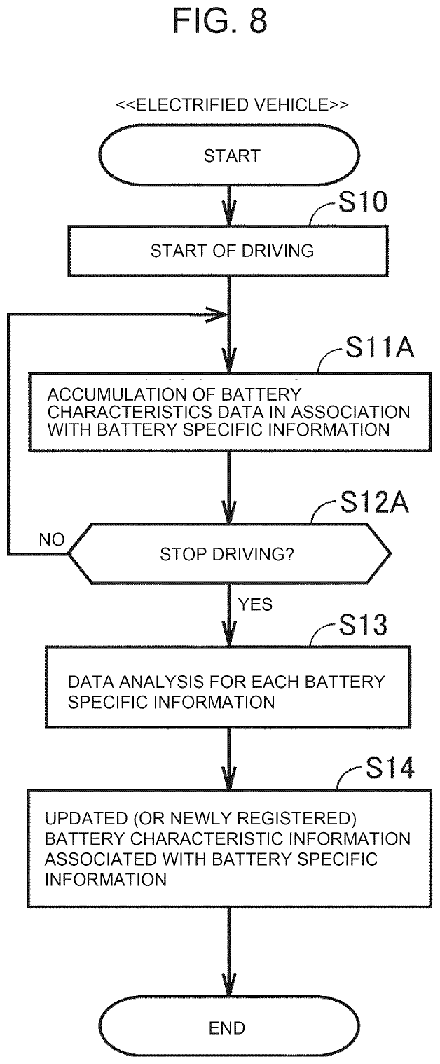

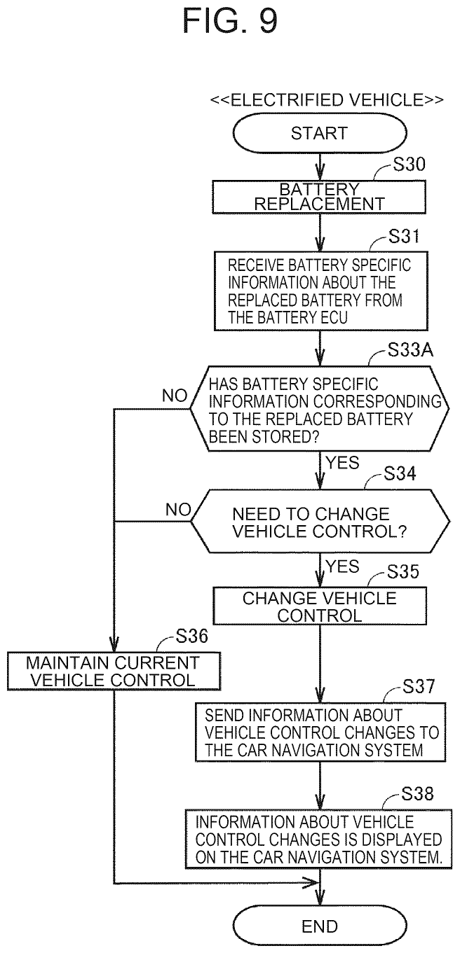

Next, referring to FIG. 8 and FIG. 9, the control methods relating to the change of the vehicle control of electrified vehicle 100A will be described. Steps in which the same processing as in the first embodiment is performed are denoted by the same reference numerals and will not be described repeatedly.

FIG. 8 shows a sequence when the information of the memory 2A is updated based on the battery characteristic information when electrified vehicle 100A is driven.

In S11A, the vehicle ECU 10A accumulates battery property data of the battery pack 30 during traveling of electrified vehicle 100A in association with battery specific information of the battery pack 30.

In S12A, the vehicle ECU 10A determines whether or not the travel of electrified vehicle 100A has stopped. When it is determined that the traveling of electrified vehicle 100A is stopped (Yes in S12A), the process proceeds to S13. When it is determined that the traveling of electrified vehicle 100A is not stopped (No in S12A), the process returns to S11A.

In S13, the vehicle ECU 10A performs data analysis for each battery specific information by using data accumulated in S11A.

In S14, the vehicle ECU 10A updates the battery characteristic information associated with the battery specific information. Specifically, the vehicle ECU 10A updates the battery characteristic information corresponding to the battery specific information on which the data analysis is performed in S13 based on the analysis result of S13. When the battery characteristic information corresponding to the battery specific information is not stored in the memory 2A at the time of S14, the information based on the analysis result of S13 is newly registered in the memory 2A.

FIG. 9 is a diagram showing a sequence for changing the vehicle control of electrified vehicle 100A based on the battery characteristic information.

In S33A, the vehicle ECU 10A determines whether or not the battery characteristic information corresponding to the battery specific information of S31 is stored in the memory 2A. That is, the vehicle ECU 10A determines whether or not there is a track record in which the battery characteristic data corresponding to the battery specific information is acquired in electrified vehicle 100A. If the battery characteristic information is stored (Yes in S33A), the process proceeds to S34. If no battery characteristic information is stored (No in S33A), the process proceeds to S36.

Note that other configurations and controls are the same as those in the first embodiment, and therefore, repeated description will not be given.

As described above, in the second embodiment, the processor 1A of the vehicle ECU 10A performs the process of changing the vehicle control using the data stored in the memory 2A of the vehicle ECU 10A. Accordingly, the vehicle ECU 10A can change the vehicle control without performing communication (radio communication) with an external device such as servers. As a consequence, it is possible to reduce the impossibility of the process in the vehicle ECU 10A (electrified vehicle 100A). In addition, unlike the case where communication is performed between the external device and the vehicle ECU (electrified vehicle), the vehicle control can be changed relatively quickly because the time required for communication (radio communication) is not required.

In the first embodiment, the vehicle ECU 10 acquires the battery characteristic information stored in the servers 200 and changes the vehicle control (changes the control parameters and the like) using the acquired battery characteristic information. For example, the server may calculate a control parameter or the like for changing the vehicle control using the battery characteristic information stored in the server, and transmit the control parameter to electrified vehicle 100.

In the first and second embodiments described above, an example in which the information on the change of the vehicle control is displayed on the car navigation device 40 has been described, but the present disclosure is not limited to this. For example, information related to a change in vehicle control may be displayed on the user terminal 150.

In the first and second embodiments described above, when the battery characteristic information corresponding to the battery pack 30 after the replacement is not stored in the server 200 (memory 2A), the vehicle control is not changed. Even in the above case, the vehicle control may be changed based on the information on the battery characteristics of the battery pack 30 after the replacement.

In the first and second embodiments described above, the battery-characteristic data is accumulated during the traveling of electrified vehicle. For example, the battery-characteristic data at the time of charge and discharge of electrified vehicle may be accumulated.

In the first and second embodiments described above, an example in which the information on the change of the vehicle control is displayed on the car navigation device 40 or the like has been described, but the present disclosure is not limited to this. For example, information regarding a change in vehicle control may be notified by voice from a speaker or the like.

Although the battery pack 30 is replaced in the first and second embodiments, the present disclosure is not limited thereto. Each of the plurality of battery cells may be replaced. In this case, the battery characteristic information for each battery cell may be managed by a server or the like.

In the second embodiment, the table 2B is stored in the memory 2A of the vehicle ECU 10A, but the present disclosure is not limited to this. The table 2B may be stored in a storage device provided in electrified vehicle 100A and different from the memory 2A.

In the first and second embodiments described above, an example has been described in which the information regarding the change of the vehicle control is notified to the user when the vehicle control is changed, but the present disclosure is not limited thereto. Information indicating that the vehicle control is not changed may also be notified to the user.

In the first and second embodiments described above, the battery specific information includes information on the type of the battery, but the present disclosure is not limited thereto. For example, the battery specific information may include information on SOH (State of Health) of the battery in addition to information on the type of the battery. In this case, the battery characteristic information may be stored separately for each SOH size (for example, every 10%) even if the types of battery are the same.

In the first and second embodiments described above, the battery characteristics are stored for each type of battery pack, but the present disclosure is not limited thereto. Battery properties may be stored for each battery pack (e.g., for each battery pack ID). In the first embodiment, the battery characteristics may not be stored for each vehicle type, and the battery characteristics may be stored for each vehicle (for each vehicle ID).

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A control device that controls an electrified vehicle mounted with a replaceable battery, the control device comprising:
a communication unit that is able to receive information stored in a storage device; and
a processor, wherein
the storage device stores battery characteristic information that shows a characteristic of the battery at a time of driving of the electrified vehicle in association with battery specific information unique to the battery, and
when the battery is replaced, the processor is configured to
acquire the battery characteristic information corresponding to the battery specific information of the battery after a replacement from the storage device through the communication unit, and
change a vehicle control in the electrified vehicle by using the battery characteristic information obtained from the storage device.

2. The control device according to claim 1, wherein the processor notifies information related to a change of the vehicle control to a user of the electrified vehicle when the vehicle control is changed by using the battery characteristic information corresponding to the battery after the replacement.

3. The control device according to claim 2, wherein the processor notifies information related to the change to the user by transmitting information related to the change to at least one of a display device mounted on the electrified vehicle and a user terminal possessed by the user.

4. The control device according to claim 1, wherein:
when the battery characteristic information corresponding to the battery after the replacement is stored in the storage device, the processor is configured to
determine whether or not it is necessary to change the vehicle control based on the battery characteristic information corresponding to the battery after the replacement stored in the storage device,
change the vehicle control when it is determined that it is necessary to change the vehicle control, and maintain a current vehicle control when it is determined that it is not necessary to change the vehicle control; and
when the battery characteristic information corresponding to the battery after the replacement is not stored in the storage device, the processor is configured to maintain the current vehicle control.

5. A control method that controls an electrified vehicle mounted with a replaceable battery, the control method comprising:
acquiring battery characteristic information that shows a characteristic of the battery at a time of driving of the electrified vehicle from a storage device that stores the battery characteristic information in association with battery specific information unique to the battery, the battery characteristic information corresponding to the battery specific information of the battery after a replacement; and
changing a vehicle control of the electrified vehicle when the battery is replaced by using the battery characteristic information corresponding to the battery after the replacement acquired in the acquiring.
